(19) United States
(12) Patent Application Publication
(10) Pub. No.: US 2023/0252619 A1
(43) Pub. Date: Aug. 10, 2023

(54) LINEAR DEFECT INSPECTION DEVICE

(71) Applicants: LG CHEM, LTD., Seoul (KR); COSS CO., LTD., Gyeonggi-do (KR)

(72) Inventors: Jae Hyun PARK, Daejeon (KR); Myoung Gon YANG, Daejeon (KR); Kyung Do LEE, Daejeon (KR); Young Woo KO, Daejeon (KR)

(21) Appl. No.: 18/011,810

(22) PCT Filed: Jul. 26, 2021
(86) PCT No.: PCT/KR2021/009603

§ 371 Date: Dec. 20, 2022

(30) Foreign Application Priority Data
Jul. 29, 2020 (KR) 10-2020-0094268

(51) Int. Cl. G06T 7/00; G01M 11/02; G06T 7/11; G06T 7/60

(52) U.S. Cl. CPC G06T 7/001; G01M 11/0278; G06T 7/11; G06T 7/60; G06T 2207/20021; G06T 2207/20221; G06T 2207/30108

(57) ABSTRACT

The present disclosure relates to a defect inspection device including: an imaging part that captures an image of a first frame having a predetermined width and a predetermined length along a width direction and a length direction of a test object, respectively; an image division part that divides the image of the first frame of the test object captured by the imaging part into a plurality of second frames smaller than the first frame along the width direction of the test object; a brightness calculation part that measures a brightness value of each of the plurality of the second frames, and calculates a defect determination value of the first frame based on the brightness values of the plurality of the second frames; and a control part that determines a line defect existing along the length direction of the test object based on the calculated defect determination value of the first frame.

### CROSS-REFERENCE TO RELATED APPLICATIONS

The present application is a National Phase entry pursuant to 35 U.S.C. § 371 of International Application No. PCT/KR2021/009603, filed on Jul. 26, 2021, and claims the benefit of and priority to Korean Patent Application No. 10-2020-0094268, filed on Jul. 29, 2020, the entire contents of which are incorporated by reference in their entirety for all purposes as if fully set forth herein.

### TECHNICAL FIELD

The present invention relates to a linear defect inspection device, and relates to, for example, a linear defect inspection device, in particular, for detecting line stains existing along the longitudinal direction in an optical member such as a polarization plate, wherein a test object of the defect inspection device comprises a web or a base material on a roll-to-roll process.

### BACKGROUND

FIG. 1 is a schematic diagram for explaining a conventional line stain determination method.

An optical member (or optical film), for example, a polarization plate (10) has a linear defect (LD) (hereinafter, also referred to as a ‘line stain’) due to air bubbles/foreign substances and the like inside a coater in a coating process for surface treatment. The line stain (LD) is formed over the predetermined regions (11, 12, 13) along the traveling direction (y-axis direction) of the polarization plate (10), and the line stain (LD) is continuously generated.

Conventionally, in order to determine the line stain (LD) of the polarization plate (10), original images captured through a camera (20) are used. In addition, the camera (20) is provided to photograph partial regions (11, 12, 13) having a predetermined width (x-axis direction) and a predetermined length (traveling direction, y-axis direction) of the polarization plate (10). In this document, the images of the partial regions captured through the camera (20) are referred to as frames (11, 12, 13). At this time, the brightness values of the frames are calculated and compared in order to detect the line stain (LD) of the polarization plate (10).

Conventionally, there was a limit in which the defect could be detected by comparing the brightness values inside one frame.

In particular, the frame images are the entire captured image of the object to be inspected, where it is difficult to store all of them in real time due to storage speed and capacity problems, and when it is difficult to confirm the original images, it becomes difficult to ascertain the cause of the defect.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### DISCLOSURE

### Technical Problem

It is a technical problem of the present invention to provide a defect inspection device capable of long-term storage of a defect image at a low capacity and determining line stain property defects by comparing the entire fabric image.

### Technical Solution

In order to solve the above problem, according to one aspect of the present invention, a defect inspection device is provided, which comprises an imaging part that captures an image of a first frame having a predetermined width and a predetermined length along a width direction and a length direction of a test object, respectively; an image division part that divides the image of the first frame of the test object captured by the imaging part into a plurality of second frames smaller than the first frame along the width direction of the test object; a brightness calculation part that measures a brightness value of each of the plurality of the second frames, and calculates a defect determination value of the first frame based on the brightness values of the plurality of the second frames; and a control part that determines a line defect existing along the length direction of the test object based on the calculated defect determination value of the first frame.

Also, the brightness calculation part may calculate a sum of brightness values of a plurality of pixels along the length direction of one of the plurality of the second frames at a predetermined position along the width direction of the test object, and calculates the defect determination value of the first frame based on the sum of the brightness values.

Furthermore, the image division part may divide the first frame into N (N is a natural number greater than 1) second frames along the width direction of the test object, and the brightness calculation part may calculate the defect determination value of the first frame based on the brightness value of each of the N second frames and the sum of brightness values of the plurality of pixels along the length direction of the second frames in a predetermined K column (K is a natural number less than or equal to N) along the width direction of the test object.

In addition, the brightness calculation part may calculate the defect determination value of the first frame based on a difference between a maximum value and an average value of the sum of brightness values of the plurality of pixels along the length direction of the second frames in a predetermined column along the width direction of the test object,.

In addition, the imaging part may capture a plurality of the first frames along the length direction of the test object, and the defect inspection device may further comprise an image merging part that sequentially positions, in the brightness calculation part, the plurality of the first frames, in which the defect determination values are set, along the length direction of the test object to generate at least a partial image of the entire image of the test object.

Also, the control part may determine line stains based on the defect determination values of the plurality of first frames arranged along the width direction of the test object, and a sum of the defect determination values of the plurality of the first frames along the length direction in a predetermined column along the width direction of the test object.

Furthermore, the control part may calculate a brightness reference value of the first frame for determining the line stain based on the difference between a maximum value and an average value of sum of the defect determination values for the plurality of first frames along the length direction in a predetermined column along the width direction of the test object.

In addition, the control part may calculate the brightness reference value of the first frame for determining the line stain based on a value obtained by dividing the difference between the maximum value and the average value of the sum of the defect determination values for a plurality of the first frames along the length direction in the predetermined column along the width direction of the test object by the number of the plurality of first frames arranged along the length direction in the predetermined column,.

In addition, the control part may determine that the line stain is included in the first frame of the test object when the defect determination value is greater than the brightness reference value of the first frame.

In addition, when two or more first frames along the length (machine, traveling) direction of the test object have defect determination values greater than the brightness reference value of the first frame, respectively, the control part may determine that the line stains are included in the two first frames of the test object.

Also, the defect inspection device may further comprise a display part for displaying the line stain determined by the control part on the test object.

In addition, the imaging part may comprise a plurality of cameras arranged along the length direction of the test object and arranged to capture a plurality of the first frames at different positions, respectively.

### Advantageous Effects

As described above, the defect inspection device according to at least one example of the present invention has the following effects.

Defective images can be stored for a long time with a low capacity, and line stain property defects can be determined by comparing the entire image of the fabric.

Also, images stored by individual cameras are integrated and stored in an image map server as one image, through which line stain defects of the fabric can be managed.

In addition, it is also possible to identify linear defects that occur periodically/continuously/in oblique lines.

### BRIEF DESCRIPTION OF DRAWINGS

FIG. 1 is a schematic diagram for explaining a conventional line stain determination method.

FIG. 2 is a schematic diagram illustrating a defect inspection device related to one example of the present invention.

FIG. 3 is a configuration diagram illustrating a defect inspection device related to one example of the present invention.

FIGS. 4 to 7 are schematic diagrams for explaining an inspection method of a defect inspection device of an optical member related to one example of the present invention.

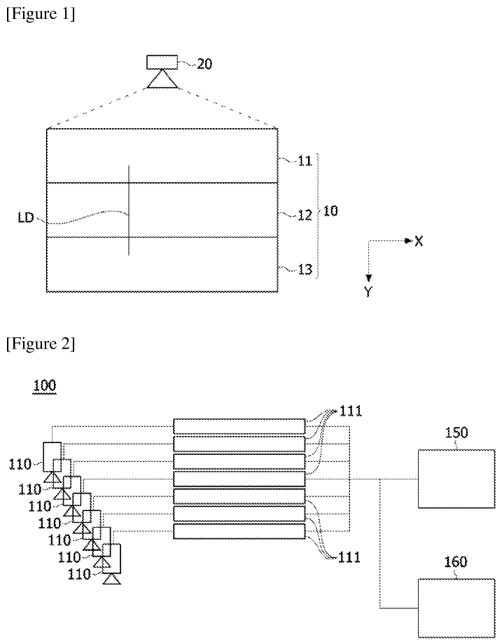

### DETAILED DESCRIPTION

Hereinafter, a defect inspection device according to one example of the present invention will be described in detail with reference to the accompanying drawings.

In addition, regardless of the reference numerals, the same or corresponding components are given the same or similar reference numbers, and duplicate descriptions thereof will be omitted, and the size and shape of each component shown for convenience of description can be exaggerated or reduced.

In this document, the test object of the bonding inspection device may comprise a web or a base material on a roll-to-roll process, and in particular, the defect inspection device related to one example of the present invention may be a defect inspection device of an optical member for detecting a line stain existing along the length direction in an optical member such as a polarization plate.

In this document, the test object may be referred to as an optical member or a polarization plate.

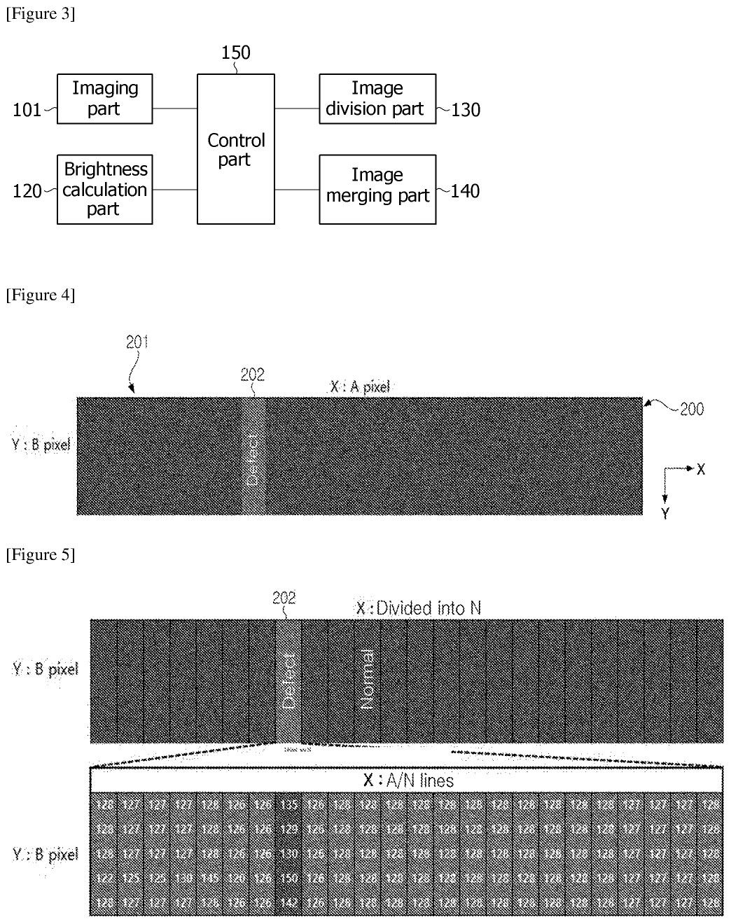

FIG. 2 is a schematic diagram illustrating a defect inspection device (100) of an optical member related to one example of the present invention, and FIG. 3 is a configuration diagram illustrating a defect inspection device of an optical member related to one example of the present invention.

In addition, FIGS. 4 to 7 are schematic diagrams for explaining an inspection method of a defect inspection device of an optical member related to one example of the present invention.

In this document, the optical member (or also referred to as a fabric) may be, for example, a polarization plate, including an optical film, and in FIGS. 4 to 7, a polarization plate will be described as an example. In addition, the line defect (LD) means a defect that occurs above a predetermined length along the traveling direction (y-axis direction) when the optical member (200) is inspected. That is, in this document, it is possible to detect the length (length along the traveling direction of the optical member) that a linear defect occurring along the traveling direction exceeds one frame. That is, when defects are each determined from two or more frames successively along the traveling direction, the relevant defects are determined as a linear defect. In this document, the traveling direction (y-axis direction) of the optical member (or ‘test object’ or ‘fabric’) is referred to as the length direction, and the direction orthogonal to the traveling direction is referred to as the width direction (x-axis direction) of the fabric.

Referring to FIGS. 2 and 3, the optical member defect inspection device (100) (hereinafter abbreviated as inspection device) comprises an imaging part (101), an image division part (130), a brightness calculation part (120), and a control part (150).

The inspection device (100) comprises an imaging part (101) disposed to photograph a first frame (201) having a first size determined by a predetermined width and a predetermined length along the width direction (x-axis direction) and the length direction (y-axis direction) of the optical member (200). The first frame (201) may comprise a plurality of pixels, and for example, the first frame (201) may comprise A pixels in the width direction and B pixels in the length direction (total: A*B pixels). For example, A may be 4096 and B may be 2048. For example, the first frame (201) may have a length of 198 mm in the length direction.

Referring to FIGS. 2 and 3, the imaging part (101) may comprise a plurality of cameras (110) arranged along the width direction of the optical member, and arranged to photograph the first frame at different positions, respectively. In FIG. 2, an unexplained reference numeral 111 denotes encoders connected to the respective cameras (110).

Referring to FIGS. 3 and 5, the inspection device (100) comprises an image division part (130) that divides the image of the first frame (201) of the optical member (200) photographed by the imaging part (101) into images of a plurality of second frames smaller than the first frame along the width direction (x-axis direction) of the optical member.

Also, the inspection device (100) comprises a brightness calculation part (120) provided to measure brightness values of the respective second frames (202), thereby calculating a defect determination value of the first frame (201).

In addition, the inspection device (100) comprises a control part (150) provided to determine a line defect existing along the length direction (y-axis direction) of the optical member based on the calculated defect determination value of the first frame (201).

Referring to FIGS. 4 to 7, the brightness calculation part (120) may be provided to calculate a sum of brightness values of a plurality (e.g., B) of pixels along the length direction of the second frame (202) at a predetermined position along the width direction (x-axis direction) of the optical member, thereby calculating the defect determination value of the first frame (201) based on the calculated sum of the brightness values.

Specifically, the image division part (130) may divide the first frame (201) into N (N is a natural number greater than 1, for example, 128) second frames (202) along the width direction of the optical member.

At this time, the brightness calculation part (120) may calculate, based on the respective brightness values for the N second frames, the defect determination value of the first frame on the basis of the sum of brightness values of a plurality of pixels along the length direction of the second frames in a predetermined K column (K is a natural number less than or equal to N) along the width direction of the optical member.

Also, the brightness calculation part (120) may calculate, based on the difference between the maximum value and the average value of sums of brightness values of a plurality of pixels along the length direction of the second frames (202) in a predetermined column along the width direction of the optical member, the defect determination value of the first frame.

Furthermore, the imaging part (101) is provided to photograph a plurality of first frames (201), respectively, along the length direction of the optical member.

In addition, the inspection device (100) may comprise an image merging part (140) that sequentially positions and merges, in the brightness calculation part (120), the first frames (201), in which the defect determination values are set, along the length direction of the optical member to generate at least a partial image of the entire image of the optical member.

Also, the control part may determine, based on the respective defect determination values for a plurality of first frames arranged along the width direction of the optical member, line stains on the basis of the sum of the defect determination values of the plurality of the first frames along the length direction in a predetermined column along the width direction of the optical member.

Furthermore, the control part may calculate, based on the difference between the maximum value and the average value of sums of defect determination values for a plurality of first frames along the length direction in a predetermined column along the width direction of the optical member, the brightness reference value of the first frame for determining the line stain.

In addition, the control part may calculate, based on the value obtained by dividing the difference between the maximum value and the average value of sums of defect determination values for a plurality of first frames along the length direction in a predetermined column along the width direction of the optical member by the number (for example, 70) of the plurality of first frames arranged along the length direction in the predetermined column, the brightness reference value of the first frame for determining the line stain.

In addition, the control part (150) may determine the first frame of the optical member having a defect determination value greater than the brightness reference value of the first frame as a line stain.

Also, the inspection device (100) may further comprise a display part (160) for displaying the line stain determined by the control part on the optical member.

Referring to FIG. 4, the first frame (201) may comprise 4096 pixels (A) in the width direction and 2048 pixels (B) in the length direction. At this time, the first frame (201) may be divided into 128 (N) second frames (202) along the width direction (x-axis direction) of the optical member. At this time, the second frame may have A/N, that is, 32 lines (vertical lines, y-axis direction).

At this time, the brightness calculation part (120) may calculate, based on the respective brightness values for the 128 second frames, the defect determination value of the first frame on the basis of the sum of brightness values of a plurality of pixels along the length direction of the second frames in a predetermined K column (K is a natural number less than or equal to N) along the width direction of the optical member, and may also calculate, based on the difference between the maximum value and the average value of sums of brightness values of a plurality (2048) of pixels along the length direction of the second frames (202) in a predetermined column along the width direction of the optical member, the defect determination value of the first frame (201).

The imaging part is provided to photograph the first frame for a plurality of regions (not overlapping) of the optical member, respectively, that are continuous along the traveling direction of the optical member. At this time, the respective regions do not overlap, and no space is generated between two adjacent regions. That is, the imaging part photographs the entire region of the optical member in units of the first frame along the traveling direction of the optical member.

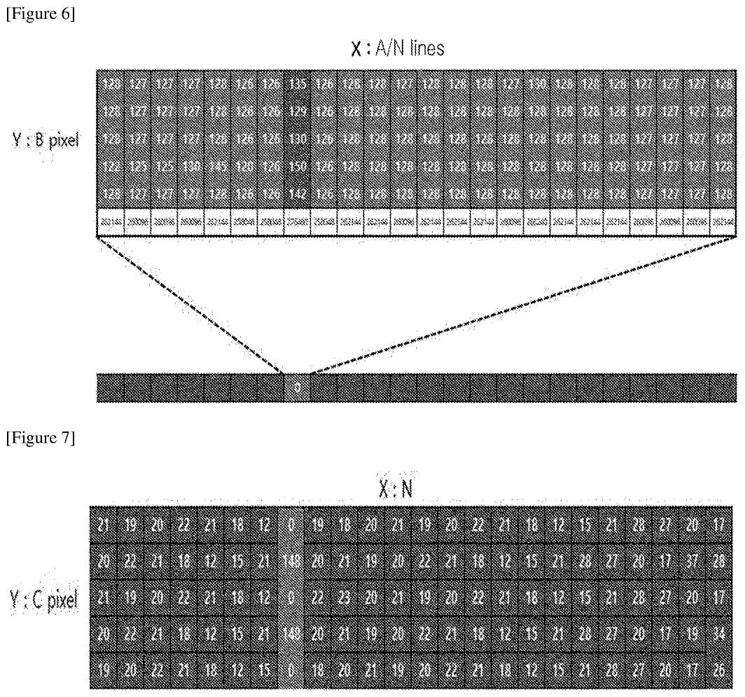

In addition, referring to FIGS. 6 and 7, a plurality of first frames (201) are each photographed along the length direction of the optical member, where the inspection device (100) may sequentially position and merge, in the brightness calculation part (120), the first frames (201) (divided images), in which the defect determination values are set, by a predetermined number (e.g., C=70, 70 frames) along the length direction of the optical member to generate at least some merged images of the entire image of the optical member.

Also, the control part may determine, based on the respective defect determination values for a plurality of first frames (202) arranged along the width direction of the optical member, line stains on the basis of the sum of the defect determination values of the plurality of the first frames along the length direction in a predetermined column along the width direction of the optical member.

Furthermore, the control part may calculate, based on the difference between the maximum value and the average value of sums of defect determination values for a plurality of first frames along the length direction in a predetermined column along the width direction of the optical member, the brightness reference value of the first frame for determining the line stain.

In addition, the control part may calculate, based on the value obtained by dividing the difference between the maximum value and the average value of sums of defect determination values for a plurality of first frames along the length direction in a predetermined column along the width direction of the optical member by the number of the plurality of first frames arranged along the length direction in the predetermined column, the brightness reference value of the first frame for determining the line stain.

In addition, it may determine the first frame of the optical member having a defect determination value greater than the brightness reference value of the first frame as a line stain.

The preferred examples of the present invention as described above are disclosed for the purpose of illustration, and various modifications, changes and additions can be made by those skilled in the art having ordinary knowledge of the present invention within the spirit and scope of the present invention, and such modifications, changes and additions shall be deemed to fall within the scope of the following claims.

### INDUSTRIAL APPLICABILITY

According to the defect inspection device related to at least one example of the present invention, defect images can be stored for a long time with a low capacity, and line stain property defects can be determined by comparing the entire image of the test object.

1. A defect inspection device comprising:
an imaging part that captures an image of a first frame having a predetermined width and a predetermined length along a width direction and a length directions of a test object, respectively;
an image division part that divides the image of the first frame of the test object captured by the imaging part into a plurality of second frames smaller than the first frame along the width direction of the test object;
a brightness calculation part that measures a brightness value of each of the plurality of the second frames, and calculates a defect determination value of the first frame based on the brightness values of the plurality of the second frames; and
a control part that determines a line defect existing along the length direction of the test object based on the calculated defect determination value of the first frame.

2. The defect inspection device according to claim 1, wherein
the brightness calculation part calculates a sum of brightness values of a plurality of pixels along the length direction of one of the plurality of the second frames at a predetermined position along the width direction of the test object, and calculates the defect determination value of the first frame based on the sum of the brightness values.

3. The defect inspection device according to claim 2,
wherein the image division part divides the first frame into N second frames along the width direction of the test object,
wherein N is a natural number greater than 1,
wherein the brightness calculation part calculates the defect determination value of the first frame based on the brightness value of each of the N second frames and the sum of the brightness values of the plurality of pixels along the length direction of the second frames in a predetermined K column along the width direction of the test object, and
wherein K is a natural number less than or equal to N.

4. The defect inspection device according to claim 3, wherein
the brightness calculation part calculates the defect determination value of the first frame based on a difference between a maximum value and an average value of the sum of brightness values of the plurality of pixels along the length direction of the second frames in a predetermined column along the width direction of the test object.

5. The defect inspection device according to claim 3,
wherein the imaging part captures a plurality of the first frames along the length direction of the test object, and
wherein the defect inspection device further comprises an image merging part that sequentially positions, in the brightness calculation part, the plurality of the first frames, in which the defect determination values are set, along the length direction of the test object to generate at least a partial image of the entire image of the test object.

6. The defect inspection device according to claim 5, wherein
the control part determines line stains based on each of the defect determination values of the plurality of the first frames arranged along the width direction of the test object, and a sum of the defect determination values of the plurality of the first frames along the length direction in a predetermined column along the width direction of the test object.

7. The defect inspection device according to claim 6, wherein
the control part calculates a brightness reference value of the first frame for determining the line stain based on the difference between a maximum value and an average value of the sum of the defect determination values for the plurality of the first frames along the length direction in the predetermined column along the width direction of the test object.

8. The defect inspection device according to claim 7, wherein
the control part calculates the brightness reference value of the first frame for determining the line stain based on a value obtained by dividing the difference between the maximum value and the average value of the sum of the defect determination values for the plurality of the first frames along the length direction in the predetermined column along the width direction of the test object by the number of the plurality of first frames arranged along the length direction in the predetermined column.

9. The defect inspection device according to claim 8, wherein
the control part determines that the line stain is included in the first frame of the test object when the defect determination value is greater than the brightness reference value of the first frame.

10. The optical member defect inspection device according to claim 9, further comprising:
a display part for displaying the line stain determined by the control part on the test object.

11. The defect inspection device according to claim 1, wherein
the imaging part comprises a plurality of cameras arranged along the length direction of the test object and arranged to capture a plurality of the first frames at different positions, respectively.
